(19) United States
(12) Patent Application Publication
(10) Pub. No.: US 2008/0223736 A1
(43) Pub. Date: Sep. 18, 2008

(54) PAINT CONTAINING DEVICE

(75) Inventor: Alessandro Nespoli, Sirtori (Lecco) (IT)

Correspondence Address: LADAS & PARRY, 5670 WILSHIRE BOULEVARD, SUITE 2100, LOS ANGELES, CA, 90036-5679, US

(73) Assignee: NESPOLI ENGINEERING KKFT, Budapest (HU)

(21) Appl. No.: 12/041,488

(22) Filed: Mar. 3, 2008

(30) Foreign Application Priority Data
Mar. 15, 2007 (IT) MI2007A000515

(51) Int. Cl. B44D 3/00; B65D 1/34; B65D 25/28

(52) U.S. Cl. 206/1.7; 206/557; 220/752

(57) ABSTRACT

The paint containing device comprises a first tray and an inclined surface along which a roller can be passed in order to be squeezed to eliminate the excess paint. It also comprises a second tray connected to the first tray such that, when the paint is low in the first tray, it can be supplemented by taking it from the second tray.

### FIELD OF THE INVENTION

The present invention relates to a paint containing device.

### BACKGROUND OF THE INVENTION

In particular, reference will be made hereinafter to containing devices for paint of the type usually used for painting walls or surfaces in general.

### DISCUSSION OF THE RELATED ART

These devices (different from the cans in which paint is usually sold) are provided with a tray into which the paint is poured, to be then withdrawn by a brush or roller and be spread, for example on a wall.

In addition, traditional containing devices are also provided with an inclined surface over which the roller or brush used to paint the wall is passed.

In use, the paint contained in the tray is withdrawn by the roller or brush, which is passed over the inclined surface (to remove the excess paint); the roller or brush is then used to paint the desired surface.

However, the paint containing device of the indicated type also presents certain drawbacks which make it uncomfortable to use.

In particular, as the tray has a limited depth but a very large upper opening, handling the containing device becomes extremely bothersome because the large area of the paint free surface makes the paint unstable so that small movements or inclinations of the device generate an overall movement of the paint with the formation of waves of paint which can escape from the tray.

Moreover, during use only a small paint quantity is fed into the tray, both because the tray is of limited depth and cannot be filled to the rim, and because the paint must not rise as far as the level of the inclined surface otherwise the excess paint could not be removed if this surface were itself immersed in the paint.

Hence while working, new paint has to be continually poured into the tray to replace the paint consumed; this operation results in lost time and, if working on a ladder (as is often the case), fatigue to the operator, who is compelled to continuously climb up and down the ladder.

### SUMMARY OF THE INVENTION

The aim of the present invention is therefore to provide a paint containing device by which the stated drawbacks of the known art are eliminated.

Within the scope of this aim, an object of the invention is to provide a containing device which enables the roller or brush to be comfortably and effectively impregnated with paint but which at the same time can be handled without the risk of spillage of the contained paint to its outside.

Another object of the invention is to provide a containing device able to contain a fairly large paint quantity, such as to ensure good self-sufficiency for the operator carrying out the painting.

The indicated aim, together with these and further objects, are attained according to the present invention by a paint containing device in accordance with the accompanying claims.

Advantageously, the paint containing device of the invention can be comfortably transported and handled.

### BRIEF DESCRIPTION OF THE DRAWINGS

Further characteristics and advantages will be more evident from the description of a preferred but non-exclusive embodiment of the device of the invention, illustrated by way of non-limiting example in the accompanying drawings, in which:

FIG. 1 is a perspective view of the device of the invention;

FIG. 2 is a front elevation of the device of the invention;

FIG. 3 is a view of the device of the invention seen from above;

FIG. 4 is a section on the line IV-IV of FIG. 3; and

FIG. 5 is a section on the line V-V of FIG. 3.

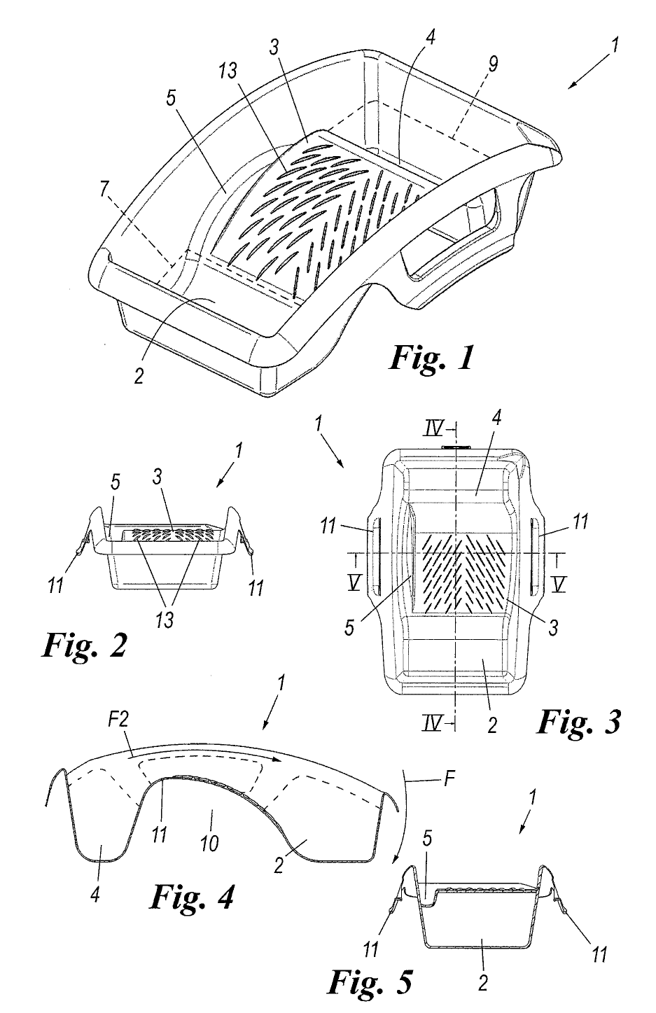

### DETAILED DESCRIPTION OF THE INVENTION

With reference to said figures, these show a paint containing device, indicated overall by the reference numeral 1.

The device 1 comprises a first tray 2 and an inclined surface 3 (of a slope which enables the excess paint to run into the tray 2) along which a roller (not shown) can be passed, to be squeezed and hence eliminate the excess paint.

The device 1 also comprises a second tray 4 connected to the first tray 2 such that, when the paint is low in the first tray 2, it can be supplemented by taking it from the second tray 4.

The first tray 2 is preferably connected to the second tray 4 by a conduit 5.

As shown in FIG. 5, the conduit 5 extends substantially at a higher height than the first and second tray 2, 4.

The first tray 2 presents an upper opening 7 of greater area than the area of the upper opening 9 of the second tray 4; the first tray 2 has a lesser depth than the second tray 4.

As shown, the inclined surface 3 is interposed between the first tray 2 and second tray 4 and is disposed beside the conduit 5.

The device 1 also presents a cavity 10 defined between the first tray 2, the second tray 4 and the inclined surface 3. This cavity 10 presents side walls in the shape of a circular arc and a flat upper wall.

To simplify its handling, two handles 11 are also provided, each of which projects from one of the ends of the cavity 10.

The inclined surface 3 presents a plurality of knurlings and/or protuberances 13 which facilitate squeezing of the roller or brush against it.

The use of the device of the invention is apparent from that described and illustrated, and is substantially as follows.

The trays 2, 4 are firstly filled with paint.

The first tray 2 presenting the large-area upper opening 7 is filled with a fairly small quantity of paint; this means that the (liquid) paint layer therein is of small thickness, so facilitating device handling and making the operations involved in impregnating the roller or brush with the paint simple and efficient.

The second tray 4 is filled with a further paint quantity such as to obtain a very deep paint layer; however, as the upper opening 9 of the second tray 4 has a small area, the quantity and depth of the liquid paint in the second tray 4 do not represent an obstacle to the handling of the device; in other words the paint contained in the second tray 4 does not tend to spill from the second tray 4 on handling the device 1.

During use, the paint is withdrawn from the first tray 2 by a roller or brush which is then (before being used) passed along the inclined surface 3 so that the excess paint is extracted from the roller or brush and falls into the first tray 2.

When the paint quantity in the first tray diminishes and more paint is to be fed into the first tray 2, the device 1 has merely to be inclined as indicated by the arrow F in FIG. 4, to cause paint to pass from the second tray 4 to the first tray 2 as indicated by the arrow F2 in FIG. 4. This paint passage takes place along the conduit 5, so preventing paint spillage and soiling of the surrounding environment.

The device 1 can be gripped by inserting the arm into the cavity 10, gripping a handle 11 with one hand and resting the forearm on the other handle 11.

This results in a firm and safe grip and easy handling of the device.

It has been found in practice that the device of the invention is comfortable and effective to use, it being easily handled while giving the operator a large reserve of paint to be applied to the wall.

In practice the materials used and the dimensions can be chosen at will according to requirements and the state of the art.

What I claim is:

1. A paint containing device comprising a first tray and an inclined surface along which a roller can be passed in order to be squeezed to eliminate the excess paint, said paint containing device further comprising a second tray connected to the first tray such that, when the paint is low in the first tray, it can be supplemented by taking it from the second tray.

2. A device as claimed in claim 1, wherein the first tray is connected to the second tray by a conduit.

3. A device as claimed in claim 2, wherein said conduit extends substantially at a higher height than said first and second tray.

4. A device as claimed in claim 1, wherein said first tray presents an upper opening of greater area than the area of the upper opening of said second tray.

5. A device as claimed in claim 1, wherein said first tray is of lesser depth than said second tray.

6. A device as claimed in claim 1, wherein said inclined surface is interposed between said first and second tray.

7. A device as claimed in claim 6, wherein said inclined surface is disposed beside said conduit.

8. A device as claimed in claim 1, further presenting a cavity defined between said first tray, said second tray and said inclined surface.

9. A device as claimed in claim 8, further presenting at least one handle projecting from at least one of the ends of said cavity.

10. A device as claimed in claim 1, wherein said inclined surface presents a plurality of knurlings and/or protuberances.
